(19) United States
(12) Patent Application Publication
(10) Pub. No.: US 2006/0071857 A1
(43) Pub. Date: Apr. 6, 2006

(54) Planar high-frequency or microwave antenna

(76) Inventor: Heiko Pelzer, Erkelenz (DE)

Correspondence Address: PHILIPS INTELLECTUAL PROPERTY & STANDARDS, P.O. BOX 3001, BRIARCLIFF MANOR, NY, 10510, US

(21) Appl. No.: 10/543,954

(22) PCT Filed: Jan. 26, 2004
(86) PCT No.: PCT/IB04/00222

§ 371 Date: Aug. 1, 2005

(30) Foreign Application Priority Data
Feb. 4, 2003 (EP) 03100221.5

(51) Int. Cl. H01Q 1/38

(52) U.S. Cl. 343/700 MS; 343/846

(57) ABSTRACT

A miniaturized planar multi-band antenna for HF or microwave frequencies (PIFA) is disclosed, which operates by means of a metal surface (4) defining a ground potential of the application. The operating principle is based on at least two structures (11, 21) which are essentially independent of one another and emit in wide ranges in different frequency ranges, disposed on one or more dielectric substrate(s) (1, 2), which are connected both to the ground potential of the application and to the high-frequency feeder. Other conductive structures (6) which can be resonantly or capacitively coupled enable extra frequency bands to be added. The special design of the metallized structures (11, 21) therefore enables a higher output capacity (bandwidth) than a conventional PIFA or the same output capacity for a smaller size.

The invention relates to a planar multi-band antenna for the high-frequency or microwave range (PIFA—Planar Inverted F Antenna), which can be operated in at least two frequency bands. The invention also relates to a telecommunication device incorporating a planar antenna of this type.

Electromagnetic waves in the high-frequency or microwave range are generally used for transmitting information, especially when using mobile telecommunications equipment. There is a rising demand for antennas designed to transmit and receive these waves, which can be operated in several frequency bands, each with a sufficiently large bandwidth.

In terms of the mobile telephone standard, such frequency bands are fixed at between 880 and 960 MHz (GSM900), between 1710 and 1880 MHz (GSM or DCS1800), and between 1850 and 1990 MHz (GSM1900 or PCS) for example. They also include the UMTS band (1880 to 2200 MHz), incorporating in particular CDMA wide band (1920 to 1980 MHz and 2110 to 2170 MHz) as well as the DECT standard for wireless telephones in the frequency band from 1880 to 1900 MHz and the Bluetooth standard in the frequency band from 2400 to 2483.5 MHz, which is used to exchange data between various electronic devices, such as mobile telephones, computers and electronic games equipment, for example.

It is particularly desirable, at least in a time transition range, to be able to operate mobile telephones both in at least one of the GSM frequency ranges and in the UMTS frequency range.

Apart from transmitting information, telecommunication equipment is also used for various other functions and applications, such as satellite navigation in the known GPS frequency range, for example, in which the antenna should then also be able to operate.

As it becomes more commonplace to integrate these and other functions in mobile telephones and in view of current endeavours to miniaturize equipment as far as possible, the other problem which arises is that of ensuring that there is always enough space available, which means that antennas have to be as compact as possible.

Patent specification EP 1 096 602 discloses a planar dual-band microwave antenna, in which a slot with a rectangular contour is provided in a planar conductive surface disposed above a ground surface. This slot divides the conductive surface into two surface areas of different lengths, each of which can be energized at slightly different resonance frequencies. Perpendicular to this, on one side of its conductive surface, this antenna also has a conductive planar projection extending in the direction towards the ground surface, by means of which the bandwidth of the higher resonance frequency in particular can be broadened. The bandwidth of the lower resonance frequency, on the other hand, remains essentially the same.

A disadvantage which this and other planar dual-band antennas often have is the fact that at least one of the frequency bands does not have the required bandwidth due to the high level of interaction between the regions of the conductive surface divided by the slit.

Accordingly, it is an object of the invention to propose a planar antenna of the type outlined above, which can be operated as a multi-band antenna in at least two frequency bands with a bandwidth big enough for a specifically designated application.

In particular, a planar antenna should be provided which has a sufficiently large bandwidth in at least two of the frequency bands mentioned above, one of which is the GSM 900 band.

Finally, also a planar antenna should be provided such that it can operate in at least two of the frequency bands mentioned above and it should simultaneously have relatively small dimensions or a reduced antenna volume.

This object is achieved as specified in claim 1, by means of a planar multi-band antenna having at least a first and a second metallized structure, each of which can be resonantly energized, which are spaced apart in such a way that they are able to operate at least substantially without any interaction.

A particular advantage of this solution is that combining several such metallized structures offers a very flexible way of making multi-band antennas which have a particularly large bandwidth at the resonance frequencies compared with systems known from the prior art or, if they have a lower bandwidth, are of smaller dimensions.

The dependent claims specify advantageous embodiments of the invention.

The embodiments defined in claims 4 and 5 enable antennas of particularly small dimensions to be obtained.

Claims 2, 6 and 7 specify embodiments which offer advantages in terms of radiation characteristics and the level of efficiency of the antenna.

The embodiment specified in claim 3 is particularly easy to manufacture.

The embodiments defined in claims 8 and 9 enable additional resonance frequencies to be generated.

Other details, features and advantages of the invention will become clear from the following description of preferred embodiments, given with reference to the appended drawings.

Of these:

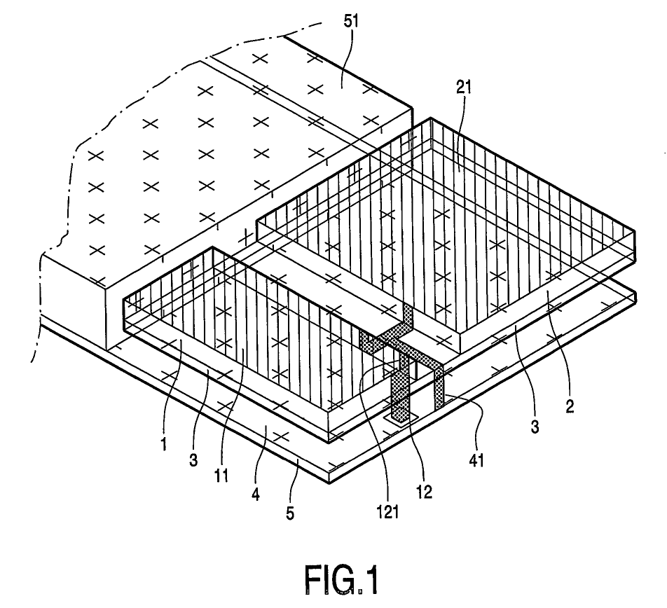

FIG. 1 is a schematic diagram of a first embodiment;

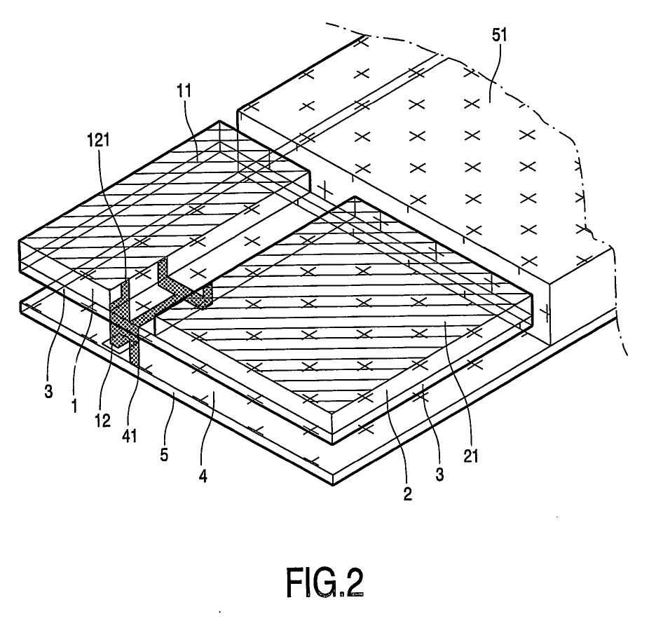

FIG. 2 is a schematic diagram showing a different view of the first embodiment;

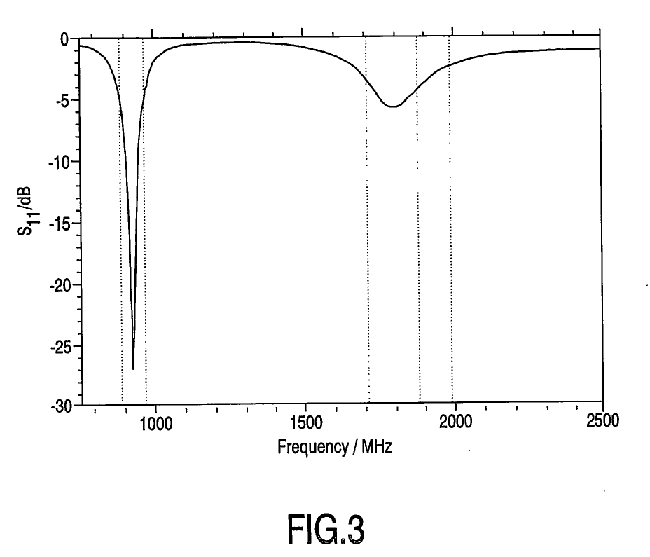

FIG. 3 plots the resonance spectrum of the antenna illustrated in FIGS. 1 and 2;

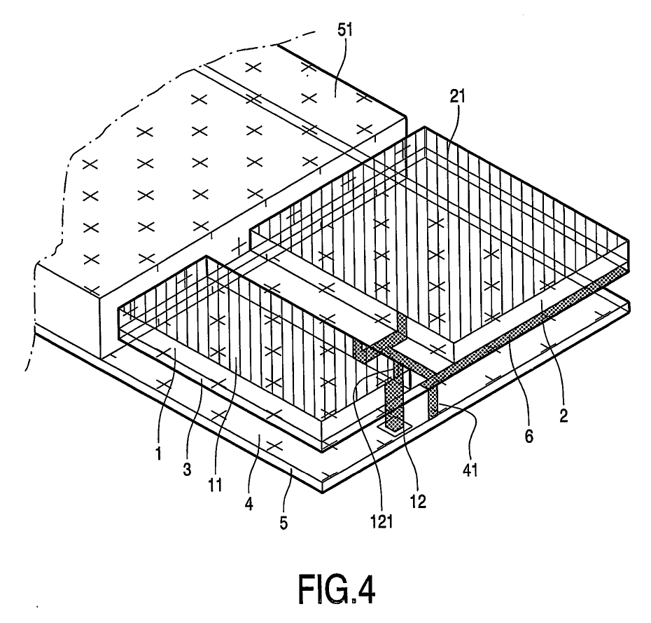

FIG. 4 is a schematic diagram of a second embodiment; and

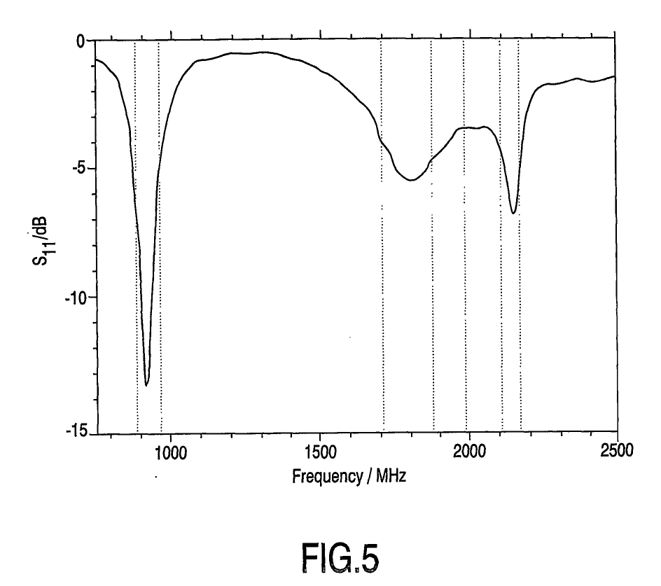

FIG. 5 plots a resonance spectrum of the antenna illustrated in FIG. 4.

FIGS. 1 and 2 show views of a first embodiment of a planar multi-band microwave antenna as proposed by the invention from different angles. The antenna comprises a first and a second substrate 1, 2, which are mounted on a common base 3 of synthetic material or plastic. This base 3 is assembled by means of spacers (not illustrated) on and at a distance apart from an electrically conductive metal surface 4. The surface 4 constitutes the reference or ground potential and may be the (metal) surface of a board 5, for example, on which other components are mounted, inter alia a battery box 51 as illustrated in this example.

Each of the two substrates 1, 2 is provided in the shape of a substantially rectangular block, the length or width of which is bigger than its height by a factor of approximately 3 to 40. In the description below, therefore, the top (large) face of each substrate 1, 2 in the drawings will be referred to as the top main face and the opposing face as the bottom main face, while the surfaces perpendicular thereto will be referred to as the side faces of the substrate 1, 2.

Instead of rectangular-shaped substrates 1, 2, however, it would also be possible to use other geometric shapes, depending on the intended application and the amount of space available, such as cylindrical bodies with a circular or triangular or polygonal shape, it also being for the first and second substrate 1, 2 to be of different shapes. The substrates 1, 2 may also contain cavities or recesses in order to save on material and hence weight, for example.

The two substrates 1, 2 are made from a ceramic material and/or one or more synthetic materials suitable for high-frequency applications or alternatively may be made by embedding a ceramic powder in a polymer matrix. It would also be possible to use pure polymer substrates. The materials should exhibit as few losses as possible and the high-frequency properties should have a low temperature dependency (NPO or so-called SL materials).

In order to reduce the size of the antenna still further, the substrates 1, 2 preferably have a dielectric constant of εᵣ>1 and/or an electric constant of μᵣ>1. However, it should be borne in mind that the achievable bandwidth decreases in substrates with a high or rising dielectric and/or electric constant. The first and second substrate 1, 2 may also be different from one another in terms of these constants.

The top main face of the two substrates 1, 2 has a metallized structure 11, 21 made from a highly conductive material such as silver, copper, gold, aluminum or a superconductor, for example, each of which constituting a resonator surface 11, 21.

The antenna has at least two electric terminals. At least one of these terminals is connected to the ground potential and at least one other terminal to a high-frequency feed. Especially in situations where only one of the metallized structures is connected to the high-frequency feed, the dimensions of the spacing are selected accordingly so that the other metallized structure(s) can be parasitically energized by means of the metallized structure receiving the power.

In the first embodiment, the two metallized structures 11, 21 are connected via a first terminal 41 to the ground potential, in particular the metal surface 4. This first terminal 41 in the example illustrated in FIGS. 1 and 2 comprises a first line portion extending upwards in a substantially vertical direction from the metal surface 4 between the substrates 1, 2, a second line portion extending perpendicular thereto in the middle between the two substrates 1, 2, and third line portions which extend from the end of the second line portion perpendicular to the two substrates 1, 2, at which point their side faces extend upwards and make contact with the metallized structures 11, 21.

A second terminal 12 is also provided as a means of supplying the antenna with electromagnetic energy to be radiated and for uncoupling the received electromagnetic energy. As illustrated in FIG. 1, this second terminal is provided in the form of a pin 12 mounted on the board 5 (and insulated from the metal surface 4). The pin 12 extends through the base 3 as far as the first substrate 1. There, the pin 12 is in contact with the metallized structure 11 either via a strip line 121 disposed on a side face of the substrate as illustrated in FIGS. 1 and 2 or is capacitively coupled by means of a contact pad provided on the end of the pin 12.

The second terminal 12 may also be disposed on the second substrate 2.

The position of the resonance frequencies of this antenna are essentially determined by the size of the metallized structures 11, 21, the larger of the two structures operating in a lower frequency range than the structure with the smaller surface area. However, the position of the resonance frequencies is also determined by the respective total length of the two terminals 41, 12 as well as the position of their end or coupling points on the substrates 1, 2.

An antenna of this type will have the following dimensions, for example:

The first substrate 1 has a length (in the direction towards the battery box 51) of 23 mm and a width of 10 mm, while the second substrate has a length of 23 mm and a width of 20 mm. The substrates 1, 2 are spaced apart from one another by a distance of 5 mm and have a thickness of 2 mm, while the thickness of the plastic base 3 is 1 mm and its distance from the metal surface 4 is 3 mm. The distance between the metal surface 4 and the bottom main face of the substrates 1, 2 is therefore 4 mm. Finally, the two substrates 1, 2 are at a distance of 2 mm from the battery box 51. The second line portion of the first terminal 41 extends across a length of approximately 5 mm in the middle between the two substrates 1, 2, while the second terminal 12 is positioned underneath the first substrate 1 at its corner adjacent to the first terminal 41 (as illustrated in FIGS. 1 and 2). All of these dimensions and positions may naturally be varied in order to influence the antenna characteristics as desired.

FIG. 3 plots the reflection parameter S₁₁ [dB] measured as a function of frequency [MHz] for the antenna illustrated in FIGS. 1 and 2. The two resonance frequencies are clearly visible, lying at approximately 930 MHz and approximately 1800 MHz. It would also be possible to use higher harmonics of this resonance frequency if necessary.

Other resonance frequencies may be generated by one or more line elements in the form of lines and/or conductive surfaces. These line elements may be connected both to the first terminal 41 and to the ground potential, as well as to the second terminal 12 and to a high-frequency line, and may be so respectively by resonant or capacitive coupling. The line elements may also be free, however, in which case they will be purely passive.

An example of this is illustrated by the second embodiment of the invention depicted in FIG. 4. The same or corresponding parts and elements of this antenna are denoted by the same reference numbers as those used in connection with FIGS. 1 and 2 and the explanation of these will therefore not be repeated.

On the bottom face of the base 3 underneath the second substrate 2, the antenna has a line element 6 extending along one side of the second substrate 2 in the form of a resonant line, which is connected via the first terminal 41 to the ground potential, in other words the metal surface 4. The path and length of this line element 6 again determine the position of the (third) resonance frequency generated as a result.

FIG. 5 plots the reflection parameter S₁₁ [dB] as a function of frequency [MHz] for the antenna illustrated in FIG. 4, having the dimensions specified above. This second embodiment enables three resonance frequencies to be generated, which lie at approximately 930 MHz (GSM900), approximately 1800 MHz (DCS1800 and PCS1900) and approximately 2150 MHz (CDMA wide band) and each of which have a relatively large bandwidth, sufficient for use of the antenna in these frequencies.

If other such line elements 6 are provided, in which case they will preferably be mounted on the bottom face of the base 3 opposing the metal surface 4, other resonance frequencies can be generated.

By contrast with the embodiments illustrated in FIGS. 1 and 2 or 4, a common substrate may also be used for both (or all) metallized structures 11, 12, provided the metallized structures 11, 12 on it are spaced at such a distance that they can operate at least substantially without any mutual electrical interaction.

The special layout of the metallized structures 11, 21 and the conductor elements 6 therefore permit a higher output capacity (bandwidth) than a conventional PIFA or (if using substrates with an appropriately high dielectric and/or electric constant) the same output capacity for a smaller size.

1. Planar multi-band antenna with at least a first and a second metallized structure (11, 21), each of which can be resonantly energized, spaced apart in such a way that they operate substantially free of interaction.

2. Antenna as claimed in claim 1,
in which at least one of the metallized structures (11, 21) is disposed above a metal surface (4) constituting a ground potential.

3. Antenna as claimed in claim 2,
in which the metallized structures (11, 21) are disposed adjacent to one another on a common base (3).

4. Antenna as claimed in claim 1,
in which at least one of the metallized structures (11, 21) is mounted on a substrate (1, 2).

5. Antenna as claimed in claim 4,
in which the substrate (1, 2) has a dielectric constant of □ᵣ>1 and/or an electric constant of μᵣ>1.

6. Antenna as claimed in claim 1,
in which at least one of the metallized structures (11, 21) is connected to a ground potential via a first terminal (41).

7. Antenna as claimed in claim 1,
in which at least one of the metallized structures (11, 21) is provided with a second terminal (12) in order to feed the antenna with electromagnetic energy to be radiated or for uncoupling received electromagnetic energy.

8. Antenna as claimed in claim 1,
with at least one line element (6) for generating at least one other resonance frequency.

9. Antenna as claimed in claim 8,
in which the line element (6) is resonantly or capacitively coupled with the ground potential or a high-frequency line or is free.

10. Telecommunication device with an antenna as claimed in claim 1.
